(19) United States
(12) Patent Application Publication
(10) Pub. No.: US 2011/0081021 A1
(43) Pub. Date: Apr. 7, 2011

(54) SCRAMBLING APPARATUS AND METHOD OF OPERATING THE SAME

(75) Inventors: Young Seok BAEK, Daejeon (KR); Bon Tae Koo, Daejeon (KR)

(73) Assignee: Electronics and Telecommunications Research Institute, Daejeon (KR)

(21) Appl. No.: 12/860,756

(22) Filed: Aug. 20, 2010

(30) Foreign Application Priority Data
Oct. 6, 2009 (KR) 10-2009-0094747

(51) Int. Cl. H04K 1/04

(52) U.S. Cl. 380/287

(57) ABSTRACT

There is provided a scrambling apparatus and a method of operating the same. A scrambling apparatus according to an aspect of the invention may include: a memory unit storing and providing a plurality of previously generated scrambling initial state codes; and a scrambling unit reading at least one of the plurality of scrambling initial state codes stored in the memory unit to generate a scrambling code in order to scramble an input signal, so that scrambling speed can be significantly increased.

### CROSS-REFERENCE TO RELATED APPLICATIONS

This application claims the priority of Korean Patent Application No. 10-2009-0094747 filed on Oct. 6, 2009, in the Korean Intellectual Property Office, the disclosure of which is incorporated herein by reference.

### BACKGROUND OF THE INVENTION

1. Field of the Invention

The present invention relates to a scrambling apparatus, and more particularly, to a scrambling apparatus that can increase scrambling speed and a method of operating the same.

2. Description of the Related Art

Digital communications systems use scrambling techniques in order to remove the correlation between signals and equalize the frequency of 0 and 1 bits in a signal.

In general, a scrambling apparatus that scrambles an input signal is provided at the transmitting side, while a descrambling apparatus that descrambles the scrambled signal to recover the original signal is provided at the receiving side. Only authenticated users are allowed to transmit and receive signals and use them.

FIG. 1 is a view illustrating the configuration of a scrambling apparatus that is applied to a digital communications system according to the related art.

Referring to FIG. 1, a scrambling apparatus includes one or more sub-scramblers 111 to 11i and an output unit 120. Each of the sub-scramblers 111 to 11i includes a plurality of delay elements DD0 to DD(k−1) and an exclusive OR gate XOR.

The scrambling apparatus having this configuration initializes the delay elements DD0 to DD(k−1) of each of the sub-scramblers 111 to 11i by using scrambling initialization codes, which are unique initial values, whenever scrambling is performed, and then repeats a shifting operation a predetermined amount of times to equalize the number of delay elements having a value ‘1’ and the number of delay elements having a value ‘0’. After completing the repeating operation, state values of the sub-scramblers at the time become scrambling initial state codes, through which scrambling codes are generated.

However, when scrambling codes are generated in this manner, a speed at which scrambling is performed, that is, scrambling speed, is greatly reduced. Thus, it takes a large amount of time to initialize the delay elements and obtain the scrambling initial state values.

As a result, the scrambling apparatus according to the related art has a relatively low scrambling speed. Therefore, it is difficult to apply the scrambling apparatus in the related art to a digital communications system that requires a high-speed operation.

### SUMMARY OF THE INVENTION

An aspect of the present invention provides a scrambling apparatus that reduces the time required to acquire a scrambling initial state code to thereby provide increased scrambling speed, and a method of operating the same.

According to an aspect of the present invention, there is provided a scrambling apparatus including: a memory unit storing and providing a plurality of previously generated scrambling initial state codes; and a scrambling unit reading at least one of the plurality of scrambling initial state codes stored in the memory unit to generate a scrambling code in order to scramble an input signal.

The scrambling apparatus may further include a scrambling initial state code generation unit sequentially increasing or decreasing values of m variable bits included in a scrambling initialization code to thereby generate the scrambling initial state codes respectively corresponding to variable values generated through a combination of m variable bits by repeating an operation of the scrambling unit.

The scrambling initialization code may include n constant bits and m variable bits, and each of the scrambling initial state codes may include k (k=n+m) constant bits.

The scrambling initial state code generation unit may store the scrambling initial state codes corresponding to the values of the m variable bits in the memory unit by using the m variable bits as an address.

The scrambling unit may read the scrambling initial state code stored in the memory unit by using the m variable bits as an address.

The scrambling unit may include: at least one sub-scrambler generating the scrambling code from the read scrambling initial state code; and an output part scrambling the input signal using the scrambling code to output the scrambled input signal to the outside.

The sub-scrambler may include: a plurality of delay elements initializing state values thereof according to the scrambling initialization code or the scrambling initial state code, and then delaying the state values for a period of time and outputting the delayed state values to next stages according to a circular shift operation; and an exclusive OR gate performing an XOR operation on at least two outputs among outputs from the plurality of delay elements and providing a result of the XOR operation as input of the delay element in the first stage.

The memory unit may include at least one memory respectively connected to the at least one sub-scrambler.

The memory may include a combinational logic circuit providing ROM or ROM function.

According to another aspect of the present invention, there is provided a method of operating a scrambling apparatus, the method including: reading a scrambling initial state code from a memory unit; generating a scrambling code from the scrambling initial state code; and scrambling an input signal through the scrambling code.

The method may further include generating the scrambling initial state code and storing the generated scrambling initial state code in the memory unit.

The storing of the generated scrambling initial state code may include: initializing m variable bits included in a scrambling initialization code; providing the scrambling initialization code including the initialized m variable bits to a scrambling unit and repeating an operation of the scrambling unit; acquiring a state value of the scrambling unit as the scrambling initial state code and storing the acquired scrambling initial state code using the m variable bits as an address when the repeating of the operation of the scrambling unit is completed; and increasing values of the m variable bits and proceeding back to the repeating of the operation of the scrambling unit when a variable value generated through a combination of the values of the m variable bits is smaller than 2m−1, and otherwise finishing the operation.

The scrambling initialization code may include n constant bits and m variable bits, and the scrambling initial state code may include k (k=n+m) constant bits.

When the scrambling unit may include a plurality of sub-scramblers and the memory unit may include a plurality of memories, the storing of the generated scrambling initial state code may be performed on each of the plurality of sub-scramblers and each of the plurality of memories.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the operation of a scrambling apparatus that is applied to a digital communications system according to the related art;

FIG. 2 is a view illustrating the configuration of a scrambling apparatus that is applied to a digital communications system according to an exemplary embodiment of the present invention;

FIGS. 3A and 3B are views illustrating the structures of a scrambling initialization code and a scrambling initialization code according to an exemplary embodiment of the present invention;

FIG. 4 is a view illustrating the detailed configurations of a memory unit and a scrambling unit according to an exemplary embodiment of the present invention;

FIG. 5 is a view illustrating examples of a memory unit according to an exemplary embodiment of the present invention;

FIG. 6 is a view illustrating a method of operating a scrambling apparatus according to an exemplary embodiment of the present invention;

FIG. 7 is an operation flow chart illustrating the detailed operation of generating and storing a scrambling initial state code according to an exemplary embodiment of the present invention; and

FIGS. 8A to 8D are views illustrating the operation of generating and storing a scrambling initial state code according to an exemplary embodiment of the present invention.

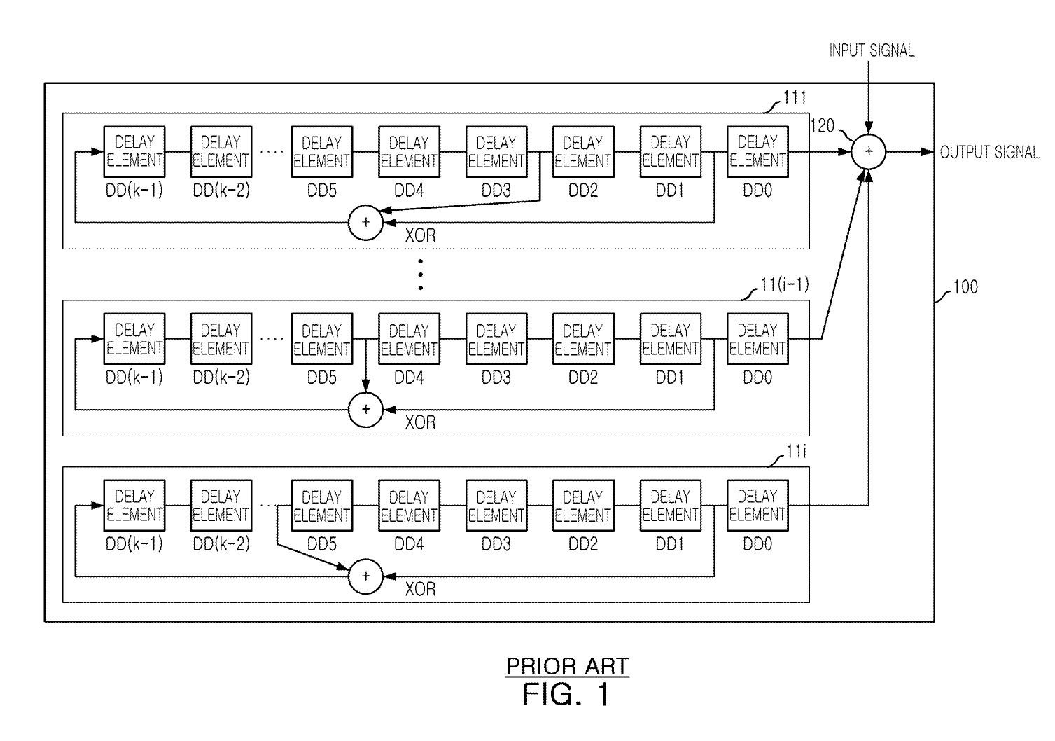

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, parts irrelevant to the description are omitted to clarify the present invention, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

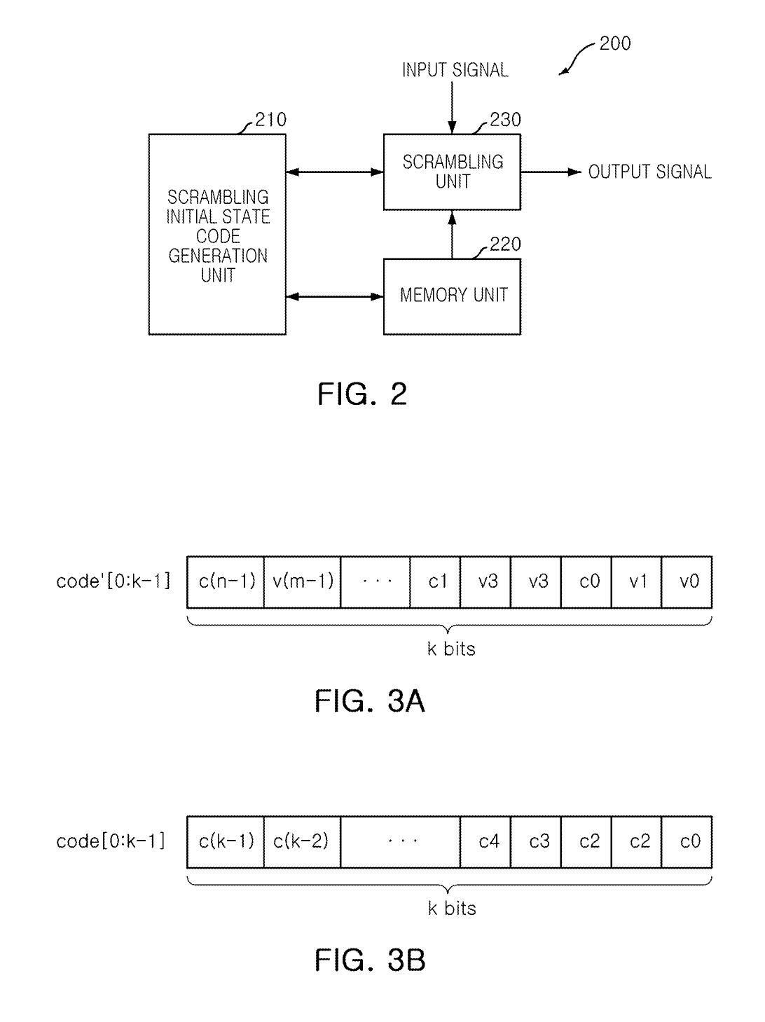

FIG. 2 is a view illustrating the configuration of a scrambling apparatus that is applied to a digital communications system according to an exemplary embodiment of the invention.

Referring to FIG. 2, a scrambling apparatus includes a scrambling initial state code generation unit 210, a memory unit 220, and a scrambling unit 230.

The scrambling initial state code generation unit 210 generates a plurality of scrambling initial state codes necessary to perform the operation of the scrambling unit 230 and stores the generated scrambling initial state codes in the memory unit 220 before the operation of the scrambling unit 230.

More specifically, while sequentially increasing (or decreasing) a value of a variable (represented in decimal system), generated through a combination of m variable bits (which are represented in binary system) included in a scrambling initialization code, the scrambling initial state code generation unit 210 repeats the operation of the scrambling unit 230 to thereby generate 2^{m} scrambling initial state codes respectively corresponding to 2^{m} variable values. The scrambling initial state code generation unit 210 stores the generated 2^{m} scrambling initial state codes in the memory unit 220, using the m variable bits as an address.

Here, a scrambling initialization code code′ [0:k−1] is used to initialize the scrambling unit 230 (particularly, sub-scramblers inside the scrambling unit) in order to generate scrambling initial state codes. As shown in FIG. 3A, the scrambling initialization code code′ [0:k−1] consists of n constant bits and m variable bits. A scrambling initial state code code[0:k−1] is used to initialize the scrambling unit 230 in order to generate a scrambling code. As shown in FIG. 3B, the scrambling initial state code code[0:k−1] consists of k (k=n+m) constant bits.

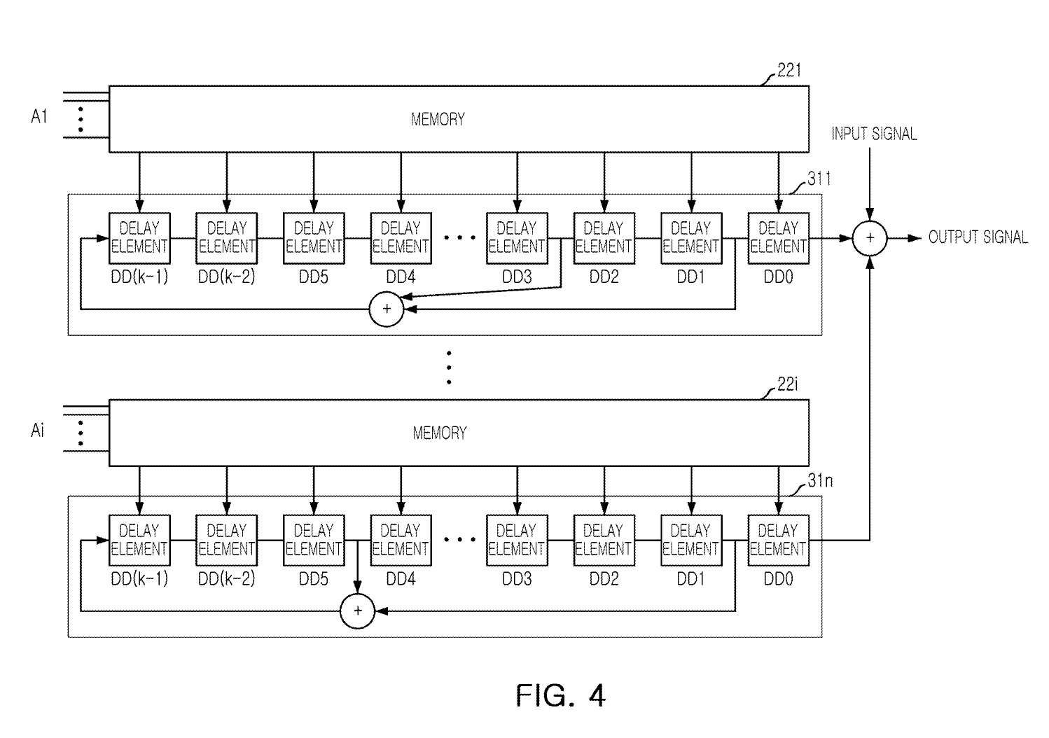

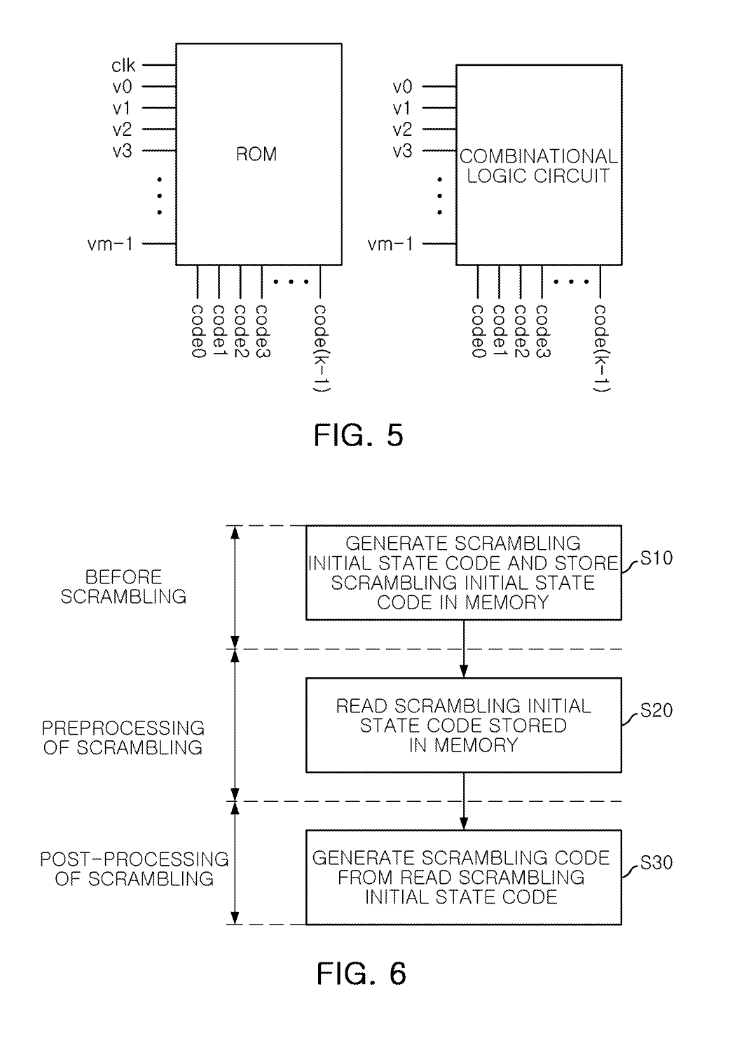

As shown in FIG. 4, the memory unit 220 may include one or more memories 221 to 22i. As shown in FIG. 5, each of the memories 221 to 22i may be realized as a combinational logic circuit that provides Read Only Memory (ROM) or ROM function. These memories 221 to 22i may use m variable bits (v[0:(m−1)] as an address to store the scrambling initial state codes generated by the scrambling initial state code generation unit 210 or read scrambling initial state codes required by the scrambling unit 230.

Here, the combinational logic circuit may be a combination of logic gates, such as AND gates, NAND gates, and OR gates, to receive the m variable bits as input and output scrambling initial state codes according to the known art.

The scrambling unit 230 reads the scrambling initial state codes from the memory unit 220 by using the m variable bits as an address in the preprocessing stage of scrambling, and generates scrambling codes from the scrambling initial state codes to thereby scramble an input signal in the post-processing stage of scrambling.

To this end, as shown in FIG. 4, the scrambling unit 230 may include one or more sub-scramblers 311 to 31i that generate scrambling codes from scrambling initial state codes read from the memory unit 220, and an output part 320 that scrambles an input signal using the scrambling codes generated by the one or more sub-scramblers 311 to 31i to thereby output a signal. Each of the sub-scramblers 311 to 31i includes k delay elements DD0 to DD(k−1) and an exclusive OR gate XOR. The k delay elements DD0 to DD(k−1) initialize their own state values in response to the scrambling initialization codes or the scrambling initial state codes, and delay their own state values for a period of time and output the delayed state values to next stages thereof according to a circular-shift operation. The exclusive OR gate XOR performs an XOR operation on two or more of the outputs from the k delay elements DD0 to DD(k−1), and provides the result as input of the delay element (DD(k−1)) in the first stage.

The one or more sub-scramblers 311 to 31i are connected to the one or more memories 221 to 22i, respectively. Each of the sub-scramblers, for example, the sub-scrambler 311 receives the scrambling initial state code in order to generate a scrambling code from each of the memories, for example, the memory 221 connected thereto.

As such, according to this embodiment, scrambling initial state codes are generated and stored before scrambling, the stored scrambling initial state codes are read during scrambling, and scrambling codes are generated using the read scrambling initial state codes.

That is, instead of generating scrambling initial state codes through the circular-shift operation of the scrambling unit 230 (that is, the sub-scramblers 311 to 31i), the scrambling initial state codes stored in the memories are read to thereby increase the operating speed of the scrambling apparatus by eliminating the time required to perform the circular-shift operation of the scrambling unit.

FIG. 6 is a view illustrating a method of operating a scrambling apparatus according to an exemplary embodiment of the invention.

Before scrambling, the scrambling initial state code generation unit 210 generates 2³ scrambling initial state codes through the scrambling unit 230 by sequentially increasing (or decreasing) the values of m variable bits in a scrambling initialization code, and stores the generated 2^{m} scrambling initial state codes in the memory unit 220 by using the m variable bits as an address in operation S10.

In the preprocessing stage of scrambling, the scrambling unit 230 reads scrambling initial state codes for scrambling from the memory unit 220 by using the m variable bits as an address in operation S20.

In the post-processing stage of scrambling, the scrambling unit 230 performs a circular-shift operation on the scrambling initial state codes through the sub-scramblers 311 to 31i to generate scrambling codes, and scrambles an input signal using the generated scrambling codes in operation S30.

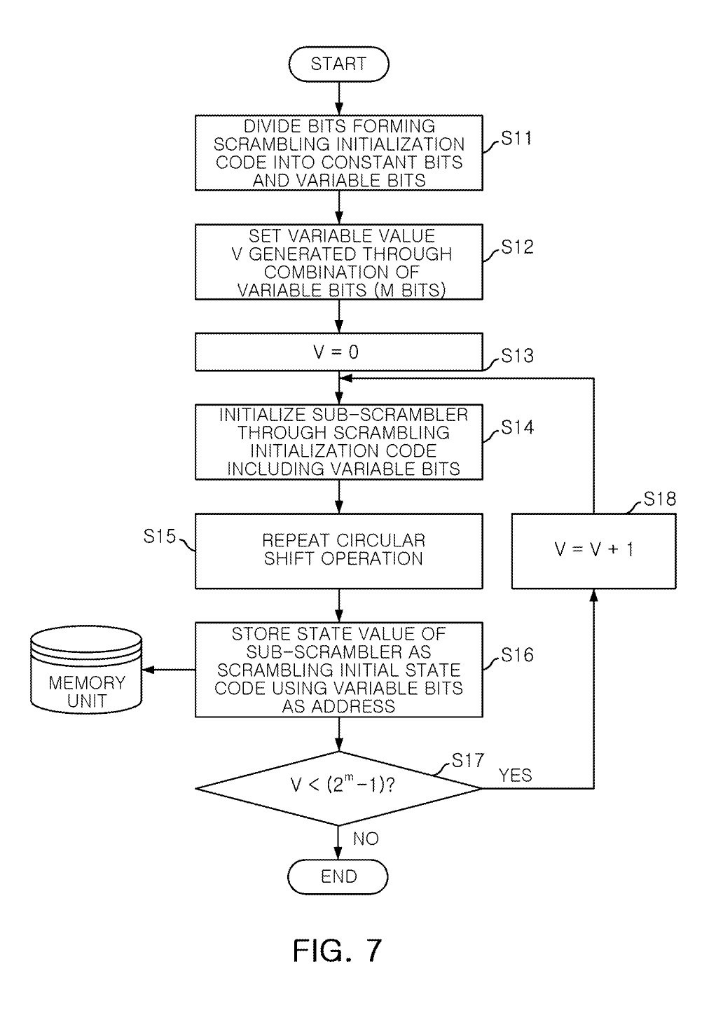

FIG. 7 is an operation flow chart illustrating the detailed operation S10 of generating and storing scrambling initial state codes according to an exemplary embodiment of the invention

If a scrambling apparatus according to an exemplary embodiment of the invention includes a plurality of sub-scramblers and memories, the operation of FIG. 7 is performed on each of the sub-scramblers and each of the memories.

Hereinafter, for convenience of explanation, a description will be made of the sub-scrambler 311 and the memory 221.

As shown in FIG. 5A, k bits forming the scrambling initialization code code′ [0:k−1] of the sub-scrambler are divided into n constant bits c[0:n−1] and m variable bits v[0:m−1] in operation S11.

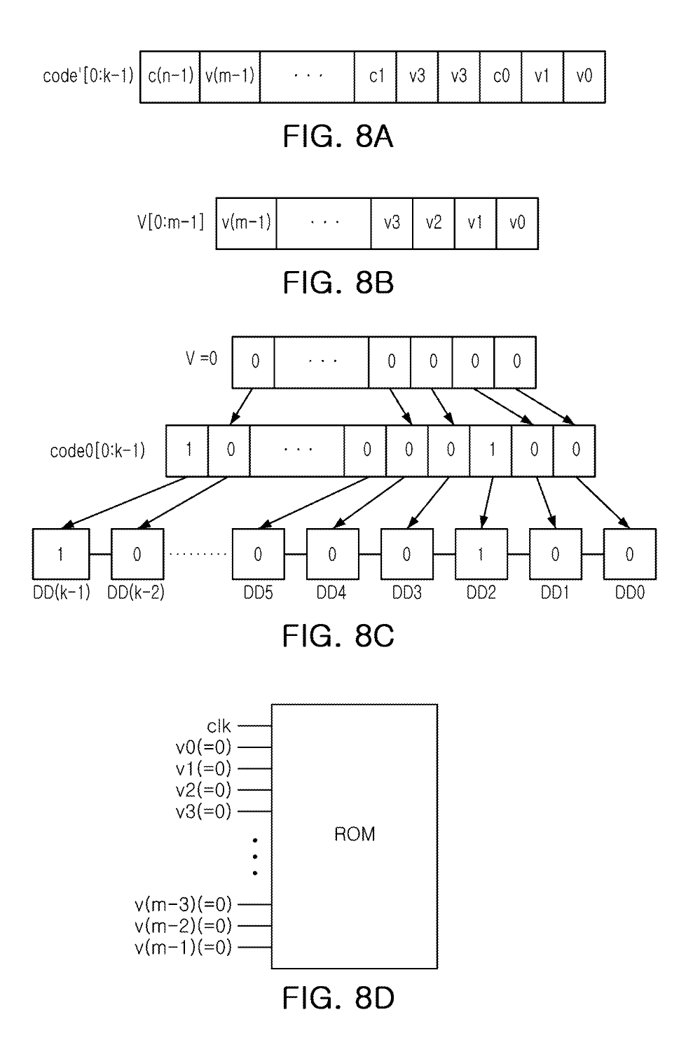

As shown in FIG. 8B, after a variable V only, generated through a combination of the m variable bits v[0:m−1], is set in operation S12, the variable V is set to ‘0’ as shown in FIG. 8C. That is, the variable bits v[0:m−1] are set to (0, . . . , 0, 0, 0, 0) in operation S13.

The scrambling initialization code code′ [0:k−1] including the variable bits v[0:m−1], set to (0, . . . , 0, 0, 0, 0), is provided to the sub-scrambler 311, for example, provided in the scrambling unit 230, to initialize the corresponding sub-scrambler 311 provided in the scrambling unit 230 in operation S14. The circular-shift operation is then repeated predetermined number of times in operation S15.

After the operation S15 is completed after a predetermined period of time has elapsed, a state value of the sub-scrambler 311 (that is, current states of the plurality of delay elements in the sub-scrambler 311) is acquired as the scrambling initial state code code[0:k−1], and the acquired scrambling initial state code code[0:k−1] is stored in the memory 221, using the variable bits v[0:m−1]=(0, . . . , 0, 0, 0, 0) as an address in operation S16.

Here, unlike the scrambling initialization code code′ [0:k−1], the scrambling initial state code code[0:k−1], stored in the memory 221 in operation S16, has k(k=n+m) constant bits respectively corresponding to the variable values V generated through a combination of the variable bits v[0:m−1].

When the variable value V is smaller than ‘2m−1’ in operation S17, the value of the variable value V is increased by ‘1’, and the process flow proceeds to the operation S14 in operation S18. When the variable value V is larger than or equal to ‘2m−1’ in operation S17, it is determined that scrambling initial state codes required by the scrambling apparatus have been generated and stored, and the process flow is completed.

Asset forth above, according to a scrambling apparatus and a method of operating the same according to exemplary embodiments of the invention, a scrambling initial state code is previously stored or configured in a memory device, such as a combinational logic circuit, which provides ROM or ROM function, before scrambling, and the scrambling initial state code is read from the memory device whenever requested. Since this reading operation is performed during one clock period, it is possible to acquire a scrambling initial state code required to perform scrambling within one clock period.

As a result, the time taken to acquire a scrambling initial state code is reduced to thereby markedly increase scrambling speed.

Furthermore, as scrambling speed is increased, the power consumed by the scrambling apparatus can also be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A scrambling apparatus comprising:
a memory unit storing and providing a plurality of previously generated scrambling initial state codes; and
a scrambling unit reading at least one of the plurality of scrambling initial state codes stored in the memory unit to generate a scrambling code in order to scramble an input signal.

2. The scrambling apparatus of claim 1, further comprising a scrambling initial state code generation unit sequentially increasing or decreasing values of m variable bits included in a scrambling initialization code to thereby generate the scrambling initial state codes respectively corresponding to variable values generated through a combination of m variable bits by repeating an operation of the scrambling unit.

3. The scrambling apparatus of claim 2, wherein the scrambling initialization code comprises n constant bits and m variable bits, and
each of the scrambling initial state codes comprises k (k=n+m) constant bits.

4. The scrambling apparatus of claim 3, wherein the scrambling initial state code generation unit stores the scrambling initial state codes corresponding to the values of the m variable bits in the memory unit by using the m variable bits as an address.

5. The scrambling apparatus of claim 4, wherein the scrambling unit reads the scrambling initial state code stored in the memory unit by using the m variable bits as an address.

6. The scrambling apparatus of claim 5, wherein the scrambling unit comprises:
at least one sub-scrambler generating the scrambling code from the read scrambling initial state code; and
an output part scrambling the input signal using the scrambling code to output the scrambled input signal to the outside.

7. The scrambling apparatus of claim 6, wherein the sub-scrambler comprises:
a plurality of delay elements initializing state values thereof according to the scrambling initialization code or the scrambling initial state code, and then delaying the state values for a period of time and outputting the delayed state values to next stages according to a circular shift operation; and
an exclusive OR gate performing an XOR operation on at least two outputs among outputs from the plurality of delay elements and providing a result of the XOR operation as input of the delay element in the first stage.

8. The scrambling apparatus of claim 6, wherein the memory unit comprises at least one memory respectively connected to the at least one sub-scrambler.

9. The scrambling apparatus of claim 8, wherein the memory comprises a combinational logic circuit providing ROM or ROM function.

10. A method of operating a scrambling apparatus, the method comprising:
reading a scrambling initial state code from a memory unit;
generating a scrambling code from the scrambling initial state code; and
scrambling an input signal through the scrambling code.

11. The method of claim 10, further comprising generating the scrambling initial state code and storing the generated scrambling initial state code in the memory unit.

12. The method of claim 11, wherein the storing of the generated scrambling initial state code comprises:
initializing m variable bits included in a scrambling initialization code;
providing the scrambling initialization code including the initialized m variable bits to a scrambling unit and repeating an operation of the scrambling unit;
acquiring a state value of the scrambling unit as the scrambling initial state code and storing the acquired scrambling initial state code using the m variable bits as an address when the repeating of the operation of the scrambling unit is completed; and
increasing values of the m variable bits and proceeding back to the repeating of the operation of the scrambling unit when a variable value generated through a combination of the values of the m variable bits is smaller than 2m−1, and otherwise finishing the operation.

13. The method of claim 12, wherein the scrambling initialization code comprises n constant bits and m variable bits, and
the scrambling initial state code comprises k (k=n+m) constant bits.

14. The method of claim 12, wherein when the scrambling unit comprises a plurality of sub-scramblers and the memory unit comprises a plurality of memories, the storing of the generated scrambling initial state code is performed on each of the plurality of sub-scramblers and each of the plurality of memories.
